(19) United States
(12) Patent Application Publication
(10) Pub. No.: US 2026/0186817 A1
(43) Pub. Date: Jul. 2, 2026

(54) DYNAMIC INTERCONNECT SWITCHING FOR VIRTUAL MACHINE MIGRATION RECOVERY

(71) Applicant: INTERNATIONAL BUSINESS MACHINES CORPORATION, Armonk, NY (US)

(72) Inventors: Veeresh Jumanal, Bangalore (IN); Ravikishore Krishnamurthy, Bangalore (IN); Rizwan Sheikh Abdulla, Bangalore (IN); Shivarudrappa Satyanaik, Bengaluru (IN)

(21) Appl. No.: 19/007,736

(22) Filed: Jan. 2, 2025

(51) Int. Cl. G06F 9/455; G06F 11/14

(52) U.S. Cl. CPC G06F 9/45558; G06F 11/1415; G06F 2009/4557

(57) ABSTRACT

Dynamic interconnect switching for virtual machine (VM) migration includes selecting a first interconnect, initiating migration of the VM from a source system to a destination system over the first interconnect, and performing migration recovery based on identifying a migration failure during the migration. The migration recovery includes selecting, as between the source and the destination, a recovery system to which to recover from the migration failure. The selecting is based on a completion amount of the migration, which is based on a subset, of migration data, that has been migrated. The migration recovery also includes recovering to the recovery system using a second interconnect, different from the first interconnect, and recovery using the second interconnect includes transferring, to the recovery system, from another system of the source and the destination, and over the second interconnect, at least a portion of the migration data that exists on the other system.

### BACKGROUND

Aspects described herein relate to virtual machine environments in which live migration is to occur, and more specifically, to bolstering high-availability virtual machines through efficient recovery from virtual machine migration failures.

### SUMMARY

Shortcomings of the prior art are overcome and additional advantages are provided through the provision of a computer-implemented method. The method includes selecting a first interconnect to use in migrating a virtual machine from a source system to a destination system. The first interconnect provides a first physical channel for communication between the source system and the destination system. The method also includes initiating migration of the virtual machine from the source system to the destination system over the first interconnect. The migration of the virtual machine is to migrate migration data from the source system to the destination system. The method additionally includes performing migration recovery based on identifying a migration failure during the migration of the virtual machine from the source system to the destination system. The migration recovery includes selecting a recovery system to which to recover from the migration failure. The selected recovery system is one of the source system and the destination system. The selecting is based on a completion amount of the migration. The completion amount is based on a subset, of the migration data, that has been migrated to the destination system as part of the initiated migration. The migration recovery additionally includes recovering to the selected recovery system using a second interconnect. The second interconnect is different from the first interconnect and provides a second physical channel, different from the first physical channel, for communication between the source system and the destination system. The recovering to the selected recovery system using the second interconnect includes transferring, to the recovery system, from another system of the source system and the destination system, and over the second interconnect, at least a portion of the migration data that exists on the other system.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIGS. 2A-2D conceptually depict example migration recovery scenarios in accordance with aspects described herein;

FIG. 3 depicts further details of an example virtual machine migration code of FIG. 1 to incorporate and/or use aspects described herein;

FIG. 4 depicts an example process for virtual machine migration, in accordance with aspects described herein; and

FIGS. 5A-5C conceptually depict example scenarios of efficient interconnect selection strategies for virtual machine migration, in accordance with aspects described herein.

### DETAILED DESCRIPTION

Described herein are approaches to ensure high-availability and efficient recovery in virtual machine environments, including efficient recovery from migration failures.

Virtual machine (VM) migration is a fundamental feature in virtualization technologies. It allows for movement of virtual machine instances between physical host systems while maintaining continuous service availability. Live migration of a VM involves migration of a VM's state, including VM data, memory state, central processing unit (CPU) and input/output (I/O) device configuration, among potentially other VM data, from a source host system to a target host system. Thus, the migration involves migrating a set of migration data from the source system where the VM initially resides to the target system. There may be setup or other preparation performed at the target system, and potentially also the source system, to get ready for the migration of the data. Similar, there may be cleanup or other operations performed at the source/target after migrating the data.

VM migration serves several purposes including load balancing, hardware maintenance, resource optimization, disaster recovery, and energy efficiency, as examples. For instance, live migration enables administrators to dynamically allocate and reallocate computing resources based on changing workload demands without disrupting running services. VM migration also enables administrators to optimize resource utilization, enhance fault tolerance, and facilitate seamless infrastructure management environments.

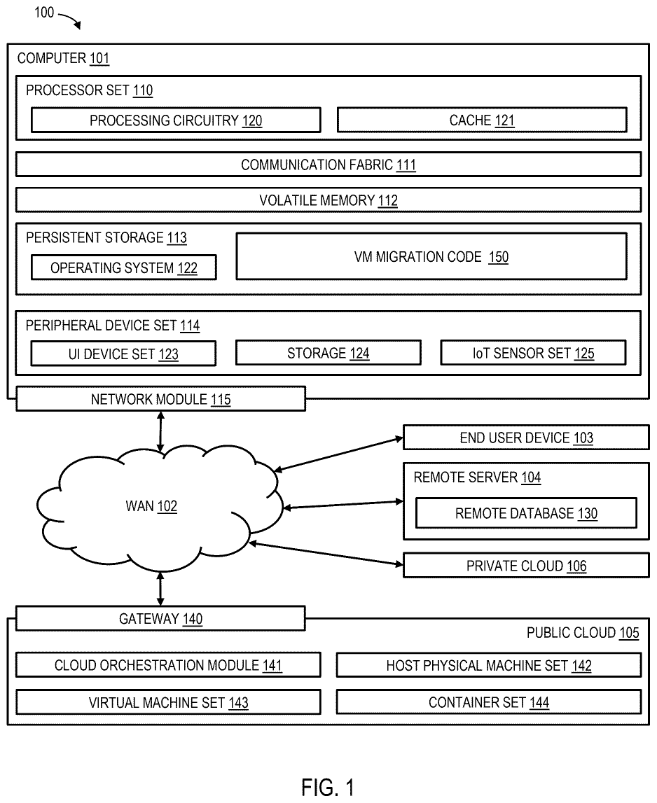

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as virtual machine migration code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, it is noted that advantages described or set-forth explicitly or implicitly herein may not be present in all embodiments described herein, and are not necessarily required of all embodiments described herein.

As noted, aspects described herein provide approaches to ensure high-availability and efficient recovery in virtual machine environments, including efficient recovery from migration failures. Virtual machine migration involves migration of a virtual machine between systems (interchangeably referred to as machines or physical servers), which could be system(s) of a same or different environment, for instance a cloud environment. In embodiments, the cloud environment is a collection of co-located systems, e.g., ‘server farm’ at a site. The virtual machine to be migrated is initially running on a source system and is to be migrated to, and run on, a destination system. Each system serves as a host that runs a hypervisor (sometimes referred to as a virtual machine monitor) that performs management of the execution of virtual machine(s) on the system. Hypervisors also perform other functions. Various virtual I/O server(s) might also be present on each of the source and destination systems. Often there is a management console, for instance a cloud hardware management console (HMC), that monitors various information including host system performance and any other desired information. The HMC might also be responsible for performing management activity (often at the request or specification of an administrator or other use via an HMC console) relative to the systems. The source and destination systems have an interconnect between them-often an Ethernet-based network interconnect-enabling them to communicate, and the migration involves movement of migration data from the source system to the destination system. There may be a central storage used by the systems, and movement of data could be effected using that storage.

The distance between host systems in an example environment can affect network latency and throughput, with higher latency seen for packets undergoing multiple hops (e.g., though multiple switches) and lower latency seen for packets traveling between systems connected directly to a same switch. Speeds can therefore vary even between systems at a single site depending on the network infrastructure at the site and components between the systems.

In some environments, there is a relatively high-speed interconnect between host systems. An example is a cache-coherent network interconnect. The Compute Express Link (CXL) standard, as an example, can be leveraged to provide an example cache-coherent network interconnect. The CXL standard defines protocol(s) for communication between components. High-speed interconnect standards are primarily designed to enable efficient communication between various components within a computing system, such as CPUs, graphics processing units (GPUs), field-programmable gate arrays (FPGAs), and other accelerators. CXL builds upon PCI Express (PCIe) technology, which is commonly used for connecting peripherals and expansion cards in computers. Memory sharing and/or direct data transfer between a CPU of a first system and working memory (such as random-access memory (RAM)) of another system can be achieved, for instance, thus enabling cache-coherence and/or other functions that demand low latency and high efficiency. Examples of high-speed, cache-coherent interconnects/protocols are CXL over a network and Open Coherent Accelerator Processor Interface (Open CAPI), which both provide standards for cache-coherent interconnection to provide a high-speed, low-latency connection between two devices.

Recovery in the context of a (failed) migration refers to the process of restoring systems, data, and applications to a stable and functional state after a migration attempt has failed. Migration failure can occur due to various reasons, for instance hardware or software issues, network problems, compatibility issues, or errors in the migration process itself.

Currently, virtual machine live migration can be performed using any of various methods. Examples include a push method, a stop-and-copy method, and a pull method. In the push method, the source VM continues running while the contents of certain memory pages (e.g., the ones holding VM data) are pushed across a connection (an Ethernet-based network interconnect, as an example) to the new destination (the target system). To ensure consistency, any memory pages of the source system that were modified during the transmission process are to be re-sent to the destination to provide it with an updated copy. In the stop-and-copy method, the VM on the source system is stopped, the contents of memory pages with VM data are copied across to the destination system, and then the new VM is started on the destination system. In the pull method, the new VM starts its execution on the destination system, and upon an attempt to access VM data on a memory page that has not yet been copied from the source to the destination, a page fault occurs at the destination, the contents of the memory page are transferred across the network from the source system to the destination system to provide the contents in a memory page of the destination system, and the attempted access can complete.

The above techniques involve copying all memory pages holding VM data from the source system to the destination system over a network channel. This can present significant issues. Since VM migration often involves moving a VM from one physical host to another physical host, if the network configurations between the hosts differ, for example they have different or incompatible virtual local area network (VLAN) setups, IP addressing schemes, and/or firewall rules, this can lead to connectivity issues post-migration. Further, network bandwidth may become constrained during migration due to the often large amount of data being transferred between the hosts. This can cause performance degradation for other virtual machines sharing the same network infrastructure. In addition, in networks with high utilization or unreliable connections, packet loss may occur during migration, leading to data corruption or incomplete migrations. Furthermore, VM migration might involve transferring sensitive data over the network. Ensuring that proper security measures are in place, such as encrypted data transmission and secure network channels, may be crucial to prevent data breaches or unauthorized access.

Aspects described herein provide a solution, for instance one operating within the hypervisor context, that monitors connectivity between the source and destination systems by periodically sending control packets during the migration process. This entity or another entity may interpret any migration failure and cause a transition what interconnect is used for the migration—the transition being from use of an initial (first) interconnect to an alternate (second) interconnect. Each different interconnect provides a different physical channel between which the systems can communicate. Example interconnects include an Ethernet-based network interconnect and a cache-coherent interconnect such as a CXL-based interconnect.

For instance, if migration initially commences using a network interconnect, such as an Ethernet-based network interconnect, but a network issue causes a migration failure during the VM migration, then aspects described herein provide a method for migration recovery using an alternative interconnect such as a cache-coherent interconnect. Similarly, if migration initially commences using a cache-coherent interconnect, such as a CXL interconnect, but an issue causes a migration failure during the VM migration, then aspects described herein provide a method for migration recovery using an alternative interconnect such as an Ethernet-based interconnect. CXL interconnects may experience failures for various reasons, including lane degradation, thermal issues, memory controller failures, and data corruption detection resulting in transfer stops, as examples.

In some examples, migration can be monitored by the hypervisors of the source and destination systems and/or a management console. Failure can be detected by any one or more of the foregoing. Based on exchanging communications before or during the migration, and/or based on agreed-upon approaches for migration recovery, one or more of the foregoing can perform processing to effect the migration recovery, including activating an alternative interconnect, initiating data transfers, or the like, as described herein. In a specific example, the HMC monitors the migration, collecting information from both systems and the network infrastructure to monitor transfer speeds and the like, and sends at least some of this information to the hypervisors. A hypervisor could issue a recovery directive to the other hypervisor, or both hypervisors could be configured to identify migration failure and take appropriate and coordinated actions described herein to perform aspects of the migration recovery.

Thus, with CXL or other cache-coherent interconnection, high-speed, low-latency communication is provided between the source and destination systems. High bandwidth helps VM migration as it allows for faster transfer of data between the source and destination hosts. Streamlined communication protocols of cache-coherent interconnects like CXL can help to minimize overhead associated with VM migration operations, resulting in faster migration times and reduced impact on system performance.

Thus, in accordance with some aspects, systems and methods are provided that enable multichannel (multiple interconnect-based) recovery of a migration operation to recover from a migration failure, including, for example, to recover the virtual machine that is the subject of the migration. This may be particularly useful in live migration (live partition mobility) failures where speed of migration and virtual machine uptime are crucial features.

In a specific example, the source and destination systems/servers are connected via an Ethernet-based network interconnect and a CXL (or other cache-coherent) interconnect, and a virtual machine executes on the source system. The source and/or destination systems may be VM host servers that host potentially multiple different VMs. A process can begin virtual machine migration using a first interconnect of the Ethernet-based network interconnect and the CXL interconnect to transfer migration data to the destination. If migration fails over the first interconnect, then a recovery and potential completion of the migration can be effected using the second interconnect to transfer migration data. For instance, if the migration fails over the Ethernet-based network interconnect, the migration recovery may proceed using the CXL interconnect, or vice versa.

In examples, a recovery system is selected. For instance, a selection can be made as between the source system and the destination system, the selection being to select one of the source system and the destination system to be the recovery system used to recover from the migration failure. The selection of the recovery system can be made based on an extent to which the migration has completed when the migration failure occurs or is identified, the extent of completion also being referred to herein as an ‘amount of completion’, or ‘completion amount’. As an example, the completion amount is, or is based on, a percentage of the VM migration process that has been completed to migrate a set of migration data over from the source system to the destination system. In an example, the migration is (among potentially other tasks) to move a set of migration data from the source system to the destination system, and the amount of completion is a proportion, percentage, or similar measure of the migration data that was successfully transferred to the destination from the source when the failure occurs.

One aspect of the recovery is the use of the second interconnect to transfer some of the migration data. Whether the migration data to transfer after failure is (i) the data that was already moved from the source to the destination before the failure or is (ii) the remaining data (the data that was not moved over prior to the failure) may be a function of which system is selected as the recovery system. Selection of the recovery system may be based on a threshold. For instance, if the migration completion meets or exceeds the threshold, meaning at least that threshold amount of migration data was successfully moved to the destination prior to the migration failure, then recovery may be done to the destination, in which case the balance of the migration data (whatever was not successfully migrated) will be transferred by the source system to the destination system over the second interconnect and the VM will be present on destination system for execution. If, instead, the migration completion is under the threshold, then recovery may be done to the source system, in which case the data that was successfully transferred to the destination server prior to the failure will be transferred by the destination system to the source system over the second interconnect and the VM will be present on source system for execution. In practice, the migration may be reinitiated at that point (possibly to leverage the second interconnect) on account that the VM never actually migrated in that scenario.

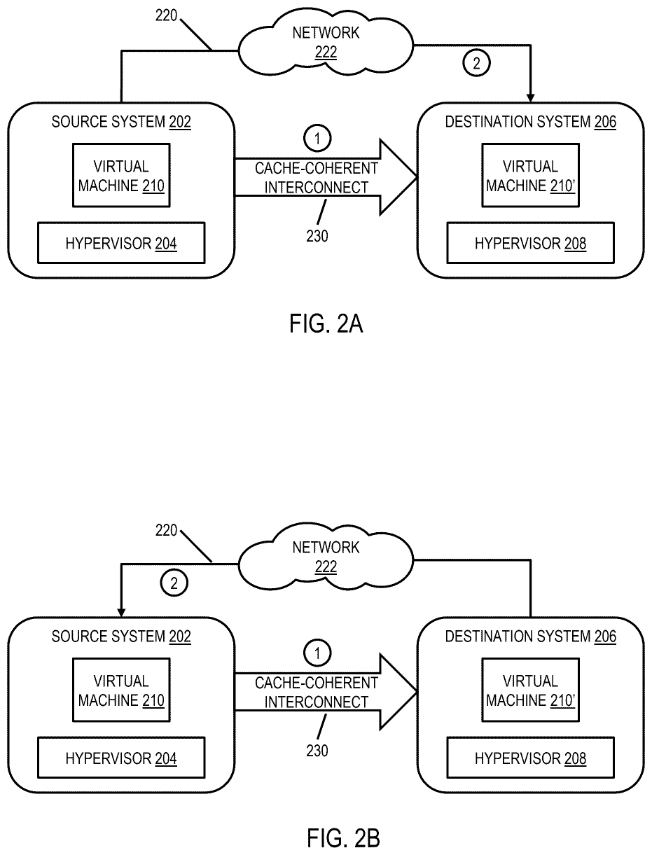

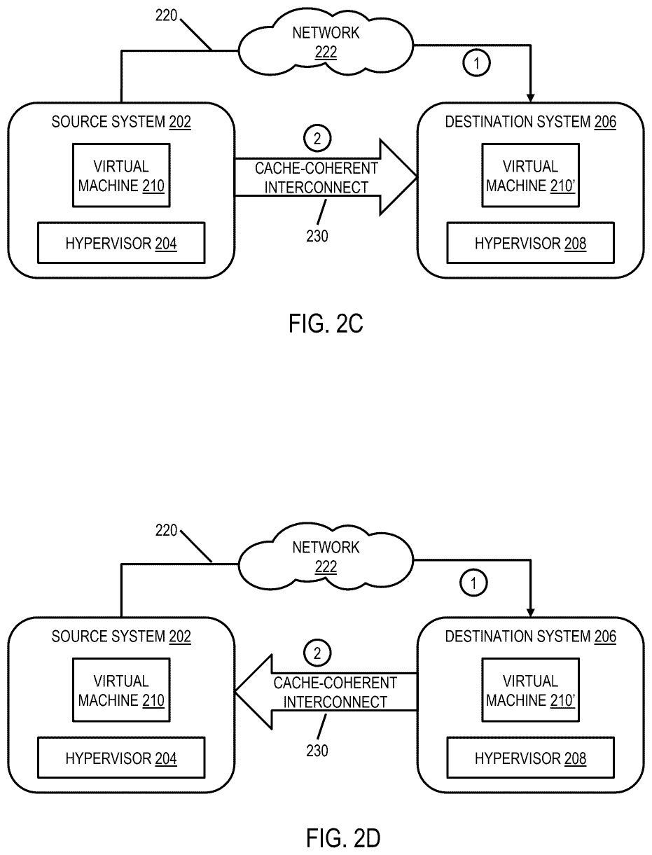

Example migration recovery scenarios are now presented and described with reference to FIGS. 2A-2D. All scenarios involve an attempted migration of a virtual machine 210 from a source system 202 running hypervisor 204 to a destination system 206 running hypervisor 208 as to-be-instantiated and executed virtual machine 210′ on the destination system. The migration involves a transfer of migration data from the source system 202 to the destination system 206. The source system 202 and destination system 206 have available multiple different interconnects between them for communicating with each other, including for transferring data therebetween. One such interconnect is an Ethernet-based network interconnect 222 that puts the source system 202 and destination system 206 in communication with each other based on their connection to an Ethernet-based network 222. Another such interconnect is a cache-coherent interconnect 230, which in these examples is a CXL interconnect between the two systems.

Referring initially to FIG. 2A, migration of virtual machine 210 from source system 202 to destination system 206 initially commences (indicated by “1”) to begin the migration over the cache-coherent interconnect 230. A subset of the migration data to be transferred from system 202 to system 206 is transferred over the cache-coherent interconnect 230 and then a failure occurs—for instance due to an issue with the cache-coherent interconnect 230. To address this failure, a recovery is initiated. In some examples, this is initiated by one or both hypervisors 204, 208.

The recovery is to be performed to either the source system or the destination system. Depending on a completion amount of the migration, the recovery system will be either the source system or the destination system. In examples, the completion amount is based on the subset, of the migration data, that has been migrated to the destination system. For instance, the completion amount may be proportion of the migration data that has been transferred as that subset of migration data. If the subset of migration data transferred is 30% of the total migration data to transfer from the source to the destination, then the completion amount can be taken to be 30%, for instance.

A threshold can be set, the threshold being used to determine which of the source system and the destination system is to be the recovery system. An example threshold used in the scenarios of FIGS. 2A-2D is 50%. In this case, if 50% or more of the migration data has been transferred to the destination system by when the failure occurs, then the destination system is selected as the recovery system, else the source system is selected as the recovery system. In other examples, a different threshold is used. The threshold could be any desired percentage, or any other threshold defining a point at which the particular system to serve as the recovery system in the event of a failure changes from one system to another system. In examples, the recovery system will be the source system up until some threshold point when the destination system is to serve as the recovery system in the event of a failure, the point being reach based on an amount of data transferred. In other embodiments, ‘completion’ of the migration is measured in something other, or in combination with, a data amount, for instance completion of a number of tasks or other activities associated with the migration.

Continuing with FIG. 2A, assume that the failure occurs at a later stage of migration, specifically after the migration is 50% or more complete. In that case, 50% or more of the migration data has been transferred to the destination system 206. A process executing on a system, such as the source system, the destination system, a management console, or another system, assess the migration state and identifies the failure, and informs one or both hypervisors with relevant data (processes, states, and/or any other data). Migration recovery is then performed. As part of this, a recovery system is selected as between the source system and the destination system. Since the threshold in this example is 50% and in this example 50% or more of the migration data has been transferred from the source system 202 to the destination system 206, the destination system 206 is selected to be the recovery server. This means that the balance of the migration data (still at the source system) is to be transferred to the destination system. As part of this recovery, however, the process determines to use an alternative interconnect, i.e., Ethernet-based network interconnect 222 in this example, to transfer the remaining data (which could optionally be achieved using the pull method of migration discussed previously). Thus, hypervisor 204 activates processes related to the Ethernet-based network interconnect 222 to take control over the data migration and transfer, to the recovery system (206 in this example), from the source system 202, and over interconnect 222, the rest of the migration data from the source to the destination system 206 (indicated by “2”). The migration is successfully completed using the Network mode of transfer, and VM 210 has been fully migrated as VM 210′.

FIG. 2B depicts a similar situation in terms of initially commencing migration over interconnect 230, except that in this example less than the threshold completion amount (i.e., less than 50%) has been reached. In this case, the recovery system is selected to be source system 202. In that case, the subset of data that was transferred to the destination system 206 is to be transferred to the source system. Processing is similar to the scenario of FIG. 2A except that hypervisor 208 activates processes related to the Ethernet-based network interconnect 222 to take control over the data migration and transfer, to the recovery system (202 in this example), from the destination system 206, and over interconnect 222, the subset of the migration data from the destination system 206 to the source system 202. This transfer back could optionally be achieved using the push method of migration discussed previously, for instance to account for any changes that may have been made to the migration data to be sent back. The migration in this example does not complete, but the failure is recovered back to the source system. At that point the migration could be re-initiated, and optionally commenced initially over interconnect 222.

FIGS. 2C and 2D depict scenarios similar to the scenarios of FIGS. 2A and 2B except that the initial interconnect used is the Ethernet-based network interconnect 222, and the failover interconnect is the cache-coherent interconnect 230. In FIG. 2C, a process initiates migration of the virtual machine 210 from the source system 202 to the destination system 206 over the Ethernet-based network interconnect 222. The completion amount has reached or exceeded the threshold (e.g., 50% or more). Hypervisor 204 activates processes related to the cache-coherent interconnect 230 to take control over the data migration and transfer, to the recovery system (206 in this example), from the source system 202, and over interconnect 230, the rest of the migration data from the source system 202 to the destination system 206 (which could optionally be achieved using the pull method of migration discussed previously). The migration is successfully completed using the cache-coherent mode of transfer, and VM 210 has been fully migrated as VM 210′.

FIG. 2D depicts a similar scenario in terms of initially commencing migration over interconnect 222, except that in this example less than the threshold completion amount (i.e., less than 50%) has been reached. In this case, the recovery system is selected to be source system 202. In that case, the subset of data that was transferred to the destination system 206 is to be transferred to the source system. Processing is similar to the scenario of FIG. 2C except that hypervisor 208 activates processes related to the cache-coherent interconnect 230 to take control over the data migration and transfer, to the recovery system (202 in this example), from the destination system 206, and over interconnect 230, the subset of the migration data from the destination system 206 to the source system 202. This transfer back could optionally be achieved using the push method of migration discussed previously. The migration in this example does not complete, but the failure is recovered back to the source system. At that point the migration could be re-initiated, and optionally commenced initially over interconnect 230.

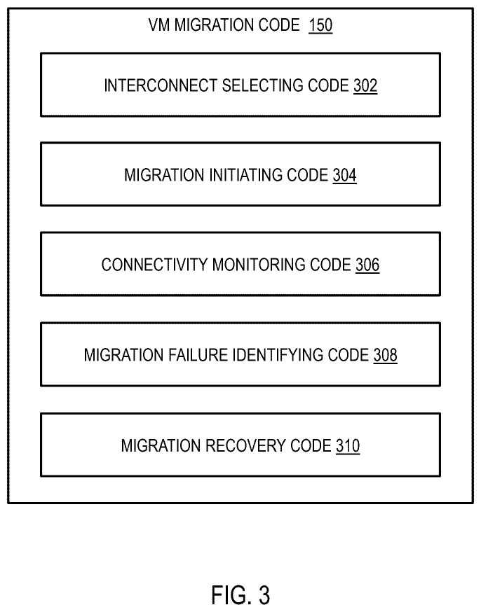

FIG. 3 depicts further details of example virtual machine migration code (e.g., virtual machine migration code 150 of FIG. 1) to incorporate and/or use aspects described herein. In one or more aspects, virtual machine migration code 150 includes, in one example, various sub-modules to be used to perform virtual machine migration. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 3, the virtual machine migration code 150 includes interconnect selecting code 302 for selecting a first interconnect to use in migrating a virtual machine from a source system to a destination system, migration initiating code 304 for initiating migration of the virtual machine from the source system to the destination system over the first interconnect, connectivity monitoring code 306 for monitoring connectivity between the source system and the destination system, migration failure identify code 308 for identifying migration failure during migration of the virtual machine from the source system to the destination system, and migration recovery code 310 for performing migration recovery in accordance with aspects described herein.

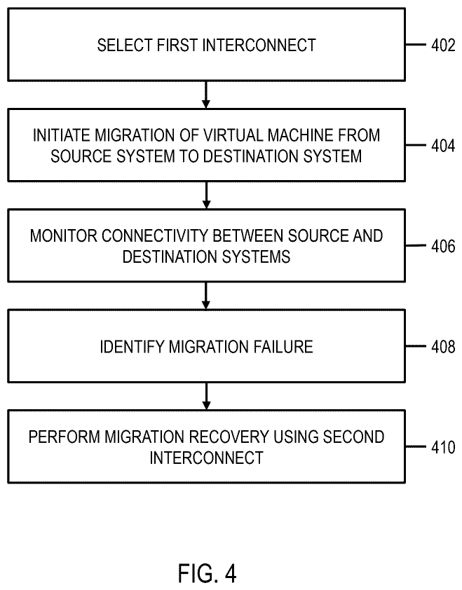

FIG. 4 depicts an example process for virtual machine migration in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 4 are part of a module, such as code module 150, which may be incorporated into one or more hypervisors of source and/or destination systems. In other examples, the code may be included in one or more code modules and/or in one or more code sub-modules of the one or more modules. Various options are available.

The process of FIG. 4 includes selecting (402) a first interconnect to use in migrating a virtual machine from a source system to a destination system. The first interconnect provides a first physical channel for communication between the source system and the destination system. The process initiates (404) migration of the virtual machine from the source system to the destination system over the first interconnect. The migration of the virtual machine is to (at least) migrate migration data from the source system to the destination system. The process optionally also monitors (406) connectivity between the source system and the destination system by sending control packets during the migration.

At some point, the process identifies (408) migration failure during migration of the virtual machine from the source system to the destination system. In examples, the process detects the migration failure based on the monitoring (406). Based on identifying the migration failure during the migration of the virtual machine from the source system to the destination system, the process performs (410) migration recovery. The migration recovery includes selecting a recovery system to which to recover from the migration failure. The selected recovery system is one of the source system and the destination system, and the selecting is based on a completion amount of the migration. The completion amount is based on a subset, of the migration data, that has been migrated to the destination server as part of the initiated migration. The migration recovery also includes recovering to the selected recovery system using a second interconnect. The second interconnect is different from the first interconnect, and provides a second physical channel, different from the first physical channel, for communication between the source system and the destination system. The recovering to the selected recovery system using the second interconnect includes transferring, to the recovery system, from another system of the source system and the destination system, and over the second interconnect, at least a portion of the migration data that exists on the other system. The other system is the system, of the source system and the destination system, that was not selected to be recovery system. As one example, based on the completion amount being above a threshold, the selecting selects the destination system as the recovery system, and the portion of the migration data is transferred from the source system (as the other system, of the two systems, that was not selected as the recovery system) to the destination system and is a remaining subset of the migration data that is to be migrated. In another example, based on the completion amount being below a threshold, the selecting selects the source system as the recovery system, and the portion of the migration data is transferred from the destination system to the source system and is the subset of the migration data that has been migrated from source system to the destination system as part of the migration prior to the migration failure.

The first and second interconnects can be different interconnects selected from an Ethernet-based network interconnects and a cache-coherent interconnect, in examples. For instance, the first interconnect can be or include a cache-coherent interconnect. Communication using the cache-coherent interconnect can uses a Compute Express Link (CXL) protocol, for instance. The second interconnect can be or include an Ethernet-based network interconnect. As another example, the first interconnect is or includes an Ethernet-based network interconnect, and the second interconnect is or includes a cache-coherent interconnect, where communication using the cache-coherent interconnect uses the Compute Express Link (CXL) protocol, for instance.

Aspects described above are directed to recovery of a virtual machine migration. Further aspects are now described for efficient interconnect selection strategies for virtual machine migration. These aspects could be used in conjunction with, or separate from, aspects described above relative to migration recovery. In an example, a process observes data transfer rates of an in-process migration and determines a switch to an alternative interconnect, after which the migration switches to using the alternative interconnect in place of an initially-selected interconnect. Switching in this manner could potentially occur more than once during a migration.

Cache-coherent interconnects can enable a source system to share its main memory to a target system. Upon sharing the memory to the target system, the target system memory experiences increased efficiency through the additional shared capacity. In some examples, cache-coherent technology uses an OpenCAPI (Open Coherent Accelerator Processor Interface) adapter/PCIe3 hardware of the systems. CXL or OpenCAPI is an open standard cache-coherent interconnect that provides a high-speed, low-latency connection between two devices. The first device can be a host system and the other device can be another system or an accelerator to which another memory or storage class device is connected.

Currently, cache-coherency technology such as CXL has various versions (e.g., CXL 1.0, CXL 2.0, etc.). However, conventional approaches do not dynamically select an appropriate CXL interconnect version or network adapter when it is being used for data sharing between two systems, such as in a virtual machine migration operation. Accordingly, aspects described herein propose changing/replacing bandwidth (e.g., from a lower bandwidth to a higher bandwidth) dynamically, live during a virtual machine migration without read/write interruption. For instance, aspects identify physical channels available for migration, estimate a duration of the migration operation from the source system to the destination system across the available channels, and select a channel for the migration. In some examples, the selection of the channel is based in whole or in part on a virtual machine priority. The priority of a virtual machine can be based on the importance of the workload/hosted applications of the virtual machine. An example selection scheme based on priority is as follows:
‘High priority’ virtual machine-Selects a relatively higher-bandwidth option, as the virtual machine requires greater resources and has a critical workload running;
‘Low priority’ virtual machine-selects a relatively lower-bandwidth option, as the virtual machine uses fewer resources.

The priority of the virtual machine could be user-driven and/or based on the kind, class, or nature of the workload on the virtual machine. In examples, the user can assign or indicate a virtual machine priority in a virtual machine profile when creating the virtual machine based on its importance.

In cases of virtual machine migration (also referred to as ‘evacuation’), the migration process often demands continuity of service and minimizing downtime of the hosted workloads. Based on these factors, a process can select a most appropriate channel as between available channels, for instance an Ethernet-based network interconnect and cache-coherent interconnect. In some examples, the most appropriate channel is the available interconnect that provides higher bandwidth, which can help accelerate the process of transferring the migration data during VM migration.

In accordance with aspects provided herein, a hypervisor (or other entity) monitors data transfer rates, detects congestion, and dictates a transition in the path used during a virtual machine migration to improve overall performance. A system/method used during a migration operation can, for instance, transition the migration's use of interconnects from a cache-coherent or Ethernet-based network interconnect of lower bandwidth to a cache-coherent or Ethernet-based network interconnect of higher bandwidth. This offers advantages particularly for workloads that demand greater data transfer speeds and reduced latency, and helps avoid limitations associated with insufficient bandwidth such as performance issues and downtime.

A process can set a priority for the virtual machine to be migrated, for instance based on a profile setting and/or on evaluating the critical workload running on the virtual machine. Based on the priority of the virtual machine, the process can select a desired initial interconnect to use for the migration process. In examples, this selection selects an adapter of the host machine, the adapter being an adapter for the cache-coherent interconnect or an adapter for the Ethernet-based network interconnect. Sometime after the transfer of migration data has begun, the method can dynamically switch from the initial interconnect to a different interconnect, for instance based on determining that the initial interconnect provides a lower bandwidth than the bandwidth of an alternative available interconnect. The switch may be effected without impacting the workload by reducing the time required for data transfer between source machine to destination machine.

In a specific example, a hypervisor determines data transfer rates between the source and destination systems by periodically sending control packets. This may be done before initiating the migration process to migrate the virtual machine. Additionally or alternatively, data transfer rates can be assessed from the rates of an ongoing migration of data (a virtual machine or otherwise) between the systems to arrive at a data transfer rate that can inform an upcoming virtual machine migration operation to occur. The hypervisor entity can also be responsible for detecting congestion during an ongoing virtual machine migration process and can determine to switch to an alternate path to improve the performance of overall virtual machine migration as described herein.

By way of specific example, a process in accordance with aspects described herein proceeds in phases as follows. In one phase, the process obtains channel details of multiple physical channels (e.g., interconnects, such as one or more cache-coherent interconnects and one or more Ethernet-based network interconnects for communication between the source and destination systems). Another type of physical channel may be a disk-based physical channel, for instance a common storage device shard by the two systems. The channel details could be obtained by sending control packets over the several channels, for instance, and gathering information obtained based on the control packets. Channel details can help inform an optimal channel for migrating the virtual machine from the source system to the destination system. Rates and capacities of channel bandwidth and/or traffic (or qualitative indications of bandwidth or traffic based on ranges or otherwise-like ‘high’ bandwidth, ‘low’ bandwidth, or similar) are examples of channel details that may be gathered and saved by the hypervisor.

In another phase, the hypervisor receives a task of virtual machine migration, and determines a channel that should be used for migration based on any of various factors. This aspect selects a channel over which to commence the virtual machine migration. The factors can be any desired factors, for instance (i) the priority of the virtual machine to be migrated, (ii) the respective current channel bandwidths of the multiple channels and/or anticipated upcoming respective bandwidth (i.e., during the migration window) of the multiple channels, and/or (iii) a number of virtual machines, for instance a number of VMs to be migrated contemporaneously using a given channel (which could include VMs any already in the process of being migrated using the channel, or could be a case where the migration is a multi-VM migration to initiate and handle multiple VM migration as a single migration).

According to the above, a channel with relatively lower bandwidth can be assigned for the migration of virtual machines of relatively lower priority. Conversely, a channel with relatively higher bandwidth can be assigned for the migration of virtual machines of relatively higher priority. In situations where a higher bandwidth channel is already at or near capacity, based on a threshold capacity level for instance, then the hypervisor could select a lower bandwidth channel in that situation even for migration of a relatively high priority virtual machine.

Additionally prior to commencing the migration, the process validates the migration. The integrity and efficiency of live virtual machine mobility can benefit from validation of the connections that the source and destination have to the channel, as well as a validation by the source and/or destination systems of the compatibility of the destination system in terms of resource and I/O compatibility to provide proper hosting of the virtual machine to be migrated.

Once validation passes, an orchestrator can initiate the next phase of virtual machine migration. Thus, after channel selection and validation, data transfer of the migration process can commence and the migration process to migrate the virtual machine migration data from the source system to the destination system can be initiated. Various migration operations are performed in this phase, including requesting allocation of resources of the destination system, creating a virtual machine profile for the virtual machine at the destination system, starting the virtual machine, copying over VM CPU and memory snapshot(s), and migrating the workload. There may be a final CPU/memory snapshot copy, and this phase ends with a delete/cleanup of the source virtual machine at the source system. The above migration operations may be performed over the selected channel that is best suited as described above, and/or performed over a combination of channels if dynamic switching between channels as described herein has occurred during the migration.

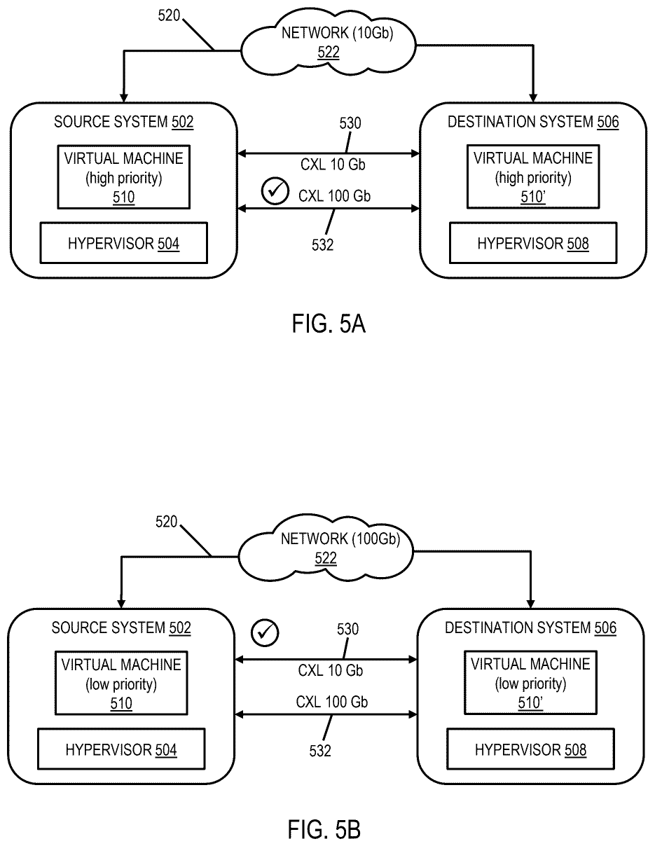

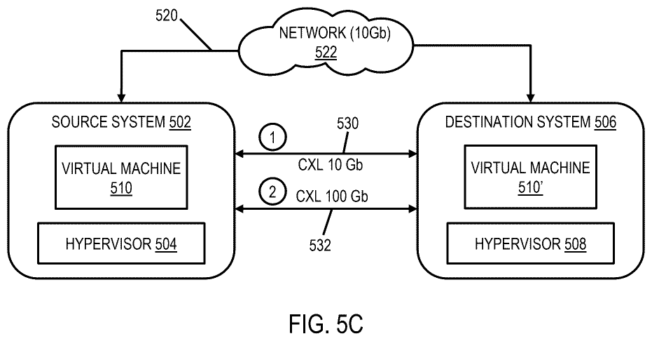

FIGS. 5A-5C conceptually depict example scenarios of efficient interconnect selection strategies for virtual machine migration, in accordance with aspects described herein. All scenarios of FIGS. 5A-5C involve an attempted migration of a virtual machine 510 from a source system 502 running hypervisor 504 to a destination system 506 running hypervisor 508 as to-be-instantiated and executed virtual machine 510′. The migration involves a transfer of migration data from the source system 502 to the destination system 506. The source system 502 and destination system 506 have available multiple different interconnects between them for communicating with each other, including for transferring data therebetween. One such interconnect is an Ethernet-based network interconnect 520 that puts the source system 502 and destination system 506 in communication with each other based on their connection to an Ethernet-based network 522. This interconnect has a determined nominal or actual transfer speed of 10 gigabit (Gb) per second in this example. There are two other interconnects in these scenarios, both cache-coherent interconnects. Interconnect 530 is a 10 Gb/second CXL-based cache-coherent interconnect and interconnect 532 is a 100 Gb/second CXL-based cache-coherent interconnect. Thus, there are three alternative physical channels depicted between the two systems, with interconnects 520 and 530 providing the same, relatively low bandwidth compared to that of the third interconnect 532. In this example virtual machine 510 is indicated as a high priority VM, for instance based on the criticality or other properties of a workload that VM 510 processes. When migration of this virtual machine is initiated from the source machine, aspects detect and gather details of VM 510 from the hypervisor 504. Since the priority of VM 510 is rated High, aspects select the higher bandwidth CXL interconnect 532 as the physical channel over which to migrate the migration data, ignoring the lower bandwidth CXL interconnect 530 and network-based interconnect 520. In accordance with aspects described previously relative to migration recovery using dynamic path switching after a migration failure, if migration is initially commenced over network interconnect 520 by a migration failure occurs, a process could transition the migration to use an alternative interconnect as described previously, and the selection of such alternative interconnect could be made as between interconnects 530 and 532 in accordance with the selection approaches described herein. At that point during migration, interconnect 532 could be selected based on the relatively high priority status of virtual machine 510. Selection of interconnect 532 over, e.g., interconnect 530 can result in an exponential decrease in the overall time taken for the migration to complete and/or recover.

FIG. 5B depicts a similar scenario to that of FIG. 5A except that the virtual machine 510 is low priority and the Ethernet-based network interconnect has a 100 Gb/second bandwidth. Here, processing selects the lower bandwidth (10 Gb/second) cache-coherent interconnect 530 on the basis of (at least) the priority of virtual machine 510 being rated as Low. The higher bandwidth (100 Gb/second) cache-coherent interconnect 532 and network based interconnect 520 are ignored in this example. This can help avoid congestion of the higher-bandwidth channels and ensure that higher priority virtual machines can be migrated over the higher-bandwidth channels if needed.

FIG. 5C depicts a scenario in which a transition is made from one channel to another during a migration. A migration failure may or may not have prompted the switch to occur.

In the scenario of FIG. 5C, migration of VM 510 was initiated to occur over the slower cache-coherent interconnect 530. The hypervisor 504 monitors data transfer rates and traffic congestion/decongestion of the various channels 520, 530, 532. Based on a current condition of these and potentially other factors, a process determines to switch to using the faster cache-coherent interconnect 532 for transferring the migration data, and informs hypervisor 504 to switch to this alternate channel. For instance, a monitoring entity might determine that there is little or no change of congestion on the higher speed interconnect 532 during a timeframe suitable for transferring the unmigrated portion of the migration data, and initiates the switch. In another example, a migration failure is experienced when using interconnect 530 and the process selects (optionally based on selection strategies discussed herein) to use interconnect 532 for failure recovery and complete the migration using interconnect 532.

Table 1 below depicts an example selection strategy for scenarios in which the Ethernet-based network interconnect has a same (or similar) bandwidth as one of two cache-coherent interconnects, with the other cache-coherent interconnect having a higher bandwidth than the other interconnects. The first column corresponds to three different migration workloads: (i) a single virtual machine of low priority, (ii) a single virtual machine of high priority, and (iii) a multiple-VM evacuation scenario in which there would be multiple VMs migrated concurrently using the same channel.

TABLE 1

| | CHANNEL | | |
|---|---|---|---|
| | Network 10 Gb | CXL 100 Gb | CXL 10 Gb |
| Single VM, low | ✓ | | ✓ |
| priority | | | |
| Single VM, high | | ✓ | |
| priority | | | |
| Multi-VM | | ✓ | |
| evacuation | | | |

By the above, in the scenario of a single, low priority virtual machine for migration, the selection strategy selects one of the lower bandwidth (10 Gb) interconnects. Selection as between the two can be dependent on other factors, such as current congestion level, as an example. In the scenario of a single, high priority virtual machine for migration, the selection strategy selects the higher bandwidth (100 Gb) cache-coherent interconnect. In the multi-VM scenario in which multiple VMs would be concurrently migrated over the selected channel-either as part of separate but concurrent migrations or as part of a single migration that migrates multiple VMs together—the higher bandwidth (100 Gb) cache-coherent interconnect is selected.

Table 2 below depicts an example selection strategy for scenarios in which the Ethernet-based network interconnect has a higher bandwidth (400 Gb) than each of two cache-coherent interconnects, with the two cache-coherent interconnects having differing (10 Gb vs. 100 Gb) bandwidths. The same three different migration workloads as discussed above are given.

TABLE 2

| | CHANNEL | | |
|---|---|---|---|
| | Network 400 Gb | CXL 100 Gb | CXL 10 Gb |
| Single VM, low | | ✓ | ✓ |
| priority | | | |
| Single VM, high | ✓ | | |
| priority | | | |
| Multi-VM | ✓ | | |
| evacuation | | | |

By the above, in the scenario of a single, low priority virtual machine for migration, the selection strategy selects one of the cache-coherent interconnects. Selection as between the two can be dependent on other factors, such as current congestion level, as an example. In the scenario of a single, high priority virtual machine for migration, the selection strategy selects the highest bandwidth interconnect which is the Ethernet-based network interconnect here at 400 Gb. Here too in the multi-VM scenario the highest bandwidth interconnect is selected.

The above are just example strategies. Various strategies are possible taking into account any desired factors.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method including:
selecting a first interconnect to use in migrating a virtual machine from a source system to a destination system, the first interconnect providing a first physical channel for communication between the source system and the destination system;
initiating migration of the virtual machine from the source system to the destination system over the first interconnect, the migration of the virtual machine to migrate migration data from the source system to the destination system; and
based on identifying a migration failure during the migration of the virtual machine from the source system to the destination system, performing migration recovery, the migration recovery including:
selecting a recovery system to which to recover from the migration failure, the selected recovery system being one of the source system and the destination system, wherein the selecting is based on a completion amount of the migration, the completion amount being based on a subset, of the migration data, that has been migrated to the destination system as part of the initiated migration; and
recovering to the selected recovery system using a second interconnect, the second interconnect being different from the first interconnect, the second interconnect providing a second physical channel, different from the first physical channel, for communication between the source system and the destination system, wherein the recovering to the selected recovery system using the second interconnect includes transferring, to the recovery system, from another system of the source system and the destination system, and over the second interconnect, at least a portion of the migration data that exists on the other system.

2. The method of claim 1, wherein based on the completion amount being above a threshold, the selecting selects the destination system as the recovery system, wherein the portion of the migration data is transferred from the source system to the destination system and is a remaining subset of the migration data that is to be migrated.

3. The method of claim 1, wherein based on the completion amount being below a threshold, the selecting selects the source system as the recovery system, wherein the portion of the migration data is transferred from the destination system to the source system and is the subset of the migration data that has been migrated from source system to the destination system as part of the migration prior to the migration failure.

4. The method of claim 1, further including monitoring connectivity between the source system and the destination system by sending control packets during the migration, and detecting the migration failure based on the monitoring.

5. The method of claim 1, wherein the first interconnect includes a cache-coherent interconnect.

6. The method of claim 5, wherein communication using the cache-coherent interconnect uses a Compute Express Link (CXL) protocol.

7. The method of claim 5, wherein the second interconnect includes an Ethernet-based network interconnect.

8. The method of claim 1, wherein the first interconnect includes an Ethernet-based network interconnect.

9. The method of claim 8, wherein the second interconnect includes a cache-coherent interconnect.

10. The method of claim 9, wherein communication using the cache-coherent interconnect uses a Compute Express Link (CXL) protocol.

11. A computer system including:
at least one computing device;
a set of one or more computer readable storage media; and
program instructions, collectively stored in the set of one or more computer readable storage media, for causing the at least one computing device to perform computer operations including:
selecting a first interconnect to use in migrating a virtual machine from a source system to a destination system, the first interconnect providing a first physical channel for communication between the source system and the destination system;
initiating migration of the virtual machine from the source system to the destination system over the first interconnect, the migration of the virtual machine to migrate migration data from the source system to the destination system; and
based on identifying a migration failure during the migration of the virtual machine from the source system to the destination system, performing migration recovery, the migration recovery including:
selecting a recovery system to which to recover from the migration failure, the selected recovery system being one of the source system and the destination system, wherein the selecting is based on a completion amount of the migration, the completion amount being based on a subset, of the migration data, that has been migrated to the destination system as part of the initiated migration; and
recovering to the selected recovery system using a second interconnect, the second interconnect being different from the first interconnect, the second interconnect providing a second physical channel, different from the first physical channel, for communication between the source system and the destination system, wherein the recovering to the selected recovery system using the second interconnect includes transferring, to the recovery system, from another system of the source system and the destination system, and over the second interconnect, at least a portion of the migration data that exists on the other system.

12. The computer system of claim 11, wherein based on the completion amount being above a threshold, the selecting selects the destination system as the recovery system, wherein the portion of the migration data is transferred from the source system to the destination system and is a remaining subset of the migration data that is to be migrated.

13. The computer system of claim 11, wherein based on the completion amount being below a threshold, the selecting selects the source system as the recovery system, wherein the portion of the migration data is transferred from the destination system to the source system and is the subset of the migration data that has been migrated from source system to the destination system as part of the migration prior to the migration failure.

14. The computer system of claim 11, wherein the first interconnect includes a cache-coherent interconnect and the second interconnect includes an Ethernet-based network interconnect.

15. The computer system of claim 11, wherein the first interconnect includes an Ethernet-based network interconnect and the second interconnect includes a cache-coherent interconnect.

16. A computer program product including:
a set of one or more computer readable storage media; and
program instructions, collectively stored in the set of one or more computer readable storage media, for causing at least one computing device to perform computer operations including:
selecting a first interconnect to use in migrating a virtual machine from a source system to a destination system, the first interconnect providing a first physical channel for communication between the source system and the destination system;
initiating migration of the virtual machine from the source system to the destination system over the first interconnect, the migration of the virtual machine to migrate migration data from the source system to the destination system; and
based on identifying a migration failure during the migration of the virtual machine from the source system to the destination system, performing migration recovery, the migration recovery including:
selecting a recovery system to which to recover from the migration failure, the selected recovery system being one of the source system and the destination system, wherein the selecting is based on a completion amount of the migration, the completion amount being based on a subset, of the migration data, that has been migrated to the destination system as part of the initiated migration; and
recovering to the selected recovery system using a second interconnect, the second interconnect being different from the first interconnect, the second interconnect providing a second physical channel, different from the first physical channel, for communication between the source system and the destination system, wherein the recovering to the selected recovery system using the second interconnect includes transferring, to the recovery system, from another system of the source system and the destination system, and over the second interconnect, at least a portion of the migration data that exists on the other system.

17. The computer program product of claim 16, wherein based on the completion amount being above a threshold, the selecting selects the destination system as the recovery system, wherein the portion of the migration data is transferred from the source system to the destination system and is a remaining subset of the migration data that is to be migrated.

18. The computer program product of claim 16, wherein based on the completion amount being below a threshold, the selecting selects the source system as the recovery system, wherein the portion of the migration data is transferred from the destination system to the source system and is the subset of the migration data that has been migrated from source system to the destination system as part of the migration prior to the migration failure.

19. The computer program product of claim 16, wherein the first interconnect includes a cache-coherent interconnect and the second interconnect includes an Ethernet-based network interconnect.

20. The computer program product of claim 16, wherein the first interconnect includes an Ethernet-based network interconnect and the second interconnect includes a cache-coherent interconnect.
